(19) United States
(12) Patent Application Publication
(10) Pub. No.: US 2026/0288315 A1
(43) Pub. Date: Sep. 24, 2026

(54) APPARATUS AND METHOD FOR GENERATING AN EXTENSIBLE ARCHITECTURE COMPRISING AT LEAST A CONTAINERIZED MODULE

(71) Applicant: Pramana, Inc., Cambridge, MA (US)

(72) Inventors: Bharathwaj Raghunathan, Oakville (CA); Abhishek Garhia, Bangalore (IN); Raghubansh Bahadur Gupta, Bangalore (IN); Suhash Gerald, Bengaluru (IN); Venkata Veera Lokeshkumar Puvvada, Guntur (IN); Prateek Jain, Karnataka (IN); Falgun Meshram, Toronto (CA); Huai-An Jeng, Toronto (CA); Prasanth Perugupalli, Cary, NC (US)

(73) Assignee: Pramana, Inc., Cambridge, MA (US)

(21) Appl. No.: 19/084,206

(22) Filed: Mar. 19, 2025

(51) Int. Cl. G06F 3/04845; G06T 3/40; G06V 10/25

(52) U.S. Cl. CPC G06F 3/04845; G06T 3/40; G06V 10/25

(57) ABSTRACT

An apparatus and method for generating an extensible architecture comprising at least a containerized module. The apparatus includes at least a processor and a memory communicatively connected to the at least a processor. The memory instructs the processor to receive container instructions associated with at least a containerized module, deploy, using the container instructions, the at least a containerized module within a containerized environment, wherein the at least a processor instantiates the containerized environment, validate, using an evaluation model, a compatibility datum of the at least a containerized module, displays, using a graphical user interface, a visualization of a process sequence, generate, using the at least a containerized module, an output of the process sequence, and display, using the graphical user interface, the output of the process sequence.

### FIELD OF THE INVENTION

The present invention generally relates to the field of modular software configuration. In particular, the present invention is directed to an apparatus and a method for generating an extensible architecture comprising at least a containerized module.

### BACKGROUND

Existing containerized architectures often face challenges related to module compatibility, validation, and extensibility, making it difficult to integrate third-party modules, dynamically validate system configurations, and optimize workflows. Additionally, conventional validation processes may not effectively leverage machine learning-driven recommendations, leading to inefficiencies in detecting and resolving compatibility errors between connected containerized modules.

### SUMMARY OF THE DISCLOSURE

In an aspect, an apparatus for generating an extensible architecture comprising at least a containerized module includes at least a processor and a memory communicatively connected to the at least a processor. The memory contains instructions configuring the processor to receive container instructions associated with at least a containerized module, deploy, using the container instructions, the at least a containerized module within a containerized environment, wherein the at least a processor instantiates the containerized environment, validate, using an evaluation model, a compatibility datum of the at least a containerized module, displaying, using a graphical user interface, a visualization of a process sequence, wherein the visualization comprises a first visual element of a plurality of visual elements, wherein the first visual element is associated with the at least a containerized module, the first visual element connected to a second visual element associated with a second containerized module, and a third visual element associated with at least a parameter of the at least a containerized module, generate, using the at least a containerized module, an output of the process sequence, and display, using the graphical user interface, the output of the process sequence.

In another aspect, a method for generating an extensible architecture comprising at least a containerized module includes receiving, using at least a processor, container instructions associated with at least a containerized module, deploying, using the container instructions, the at least a containerized module within a containerized environment, wherein the at least a processor instantiates the containerized environment, validating, using an evaluation model, a compatibility datum of the at least a containerized module, displaying, using a graphical user interface, a visualization of a process sequence, wherein the visualization comprises a first visual element of a plurality of visual elements, wherein the first visual element is associated with the at least a containerized module, the first visual element connected to a second visual element associated with a second containerized module and a third visual element associated with at least a parameter of the at least a containerized module, generating, using the at least a containerized module, an output of the process sequence, and displaying, using the graphical user interface, the output of the process sequence.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an apparatus for generating an extensible architecture comprising at least a containerized module;

FIG. 2 is an exemplary illustration of at least a containerized module comprising an obfuscation task;

FIG. 3 is an exemplary illustration of at least a containerized module comprising an imaging task;

FIG. 4 is an exemplary illustration of at least a containerized module comprising a workflow execution;

FIG. 5 is a block diagram of an exemplary machine-learning process;

FIG. 6 is a diagram of an exemplary embodiment of a neural network;

FIG. 7 is a diagram of an exemplary embodiment of a node of a neural network;

FIG. 8 is an exemplary illustration of a graphical user interface;

FIG. 9 is a block diagram of an exemplary method for generating an extensible architecture comprising at least a containerized module; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for generating an extensible architecture comprising at least a containerized module. The apparatus includes at least a computing device comprised of a processor and a memory communicatively connected to the processor. The memory instructs the processor to receive container instructions associated with at least a containerized module. The processor deploys, using the container instructions, the at least a containerized module within a containerized environment, wherein the at least a processor instantiates the containerized environment. The processor validates, using an evaluation model, a compatibility datum of the at least a containerized module. Additionally, the processor displays, using a graphical user interface, a visualization of a process sequence, wherein the visualization comprises a first visual element of a plurality of visual elements, wherein the first visual element is associated with the at least a containerized module, the first visual element connected to a second visual element associated with a second containerized module, and a third visual element associated with at least a parameter of the at least a containerized module. The processor generates, using the at least a containerized module, an output of the process sequence. The memory then instructs the processor to display, using the graphical user interface, the output of the process sequence.

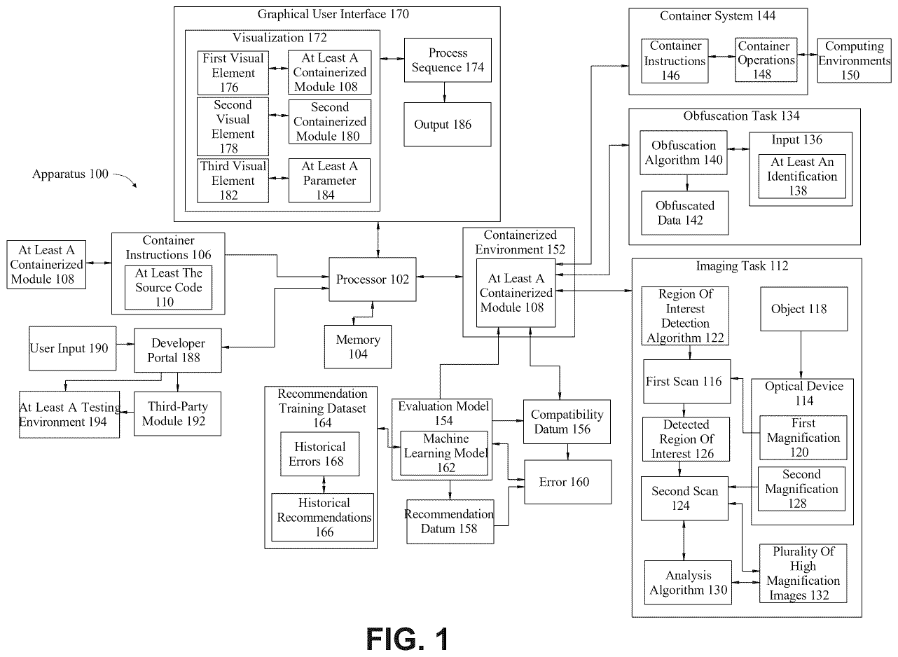

Referring now to FIG. 1, an exemplary embodiment of apparatus 100 for generating an extensible architecture comprising at least a containerized module is illustrated. Apparatus 100 may include a processor 102 communicatively connected to a memory 104. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 104 may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor 102. In one or more embodiments, data is transferred from secondary to primary memory wherein processor 102 may access the information from primary memory.

Still referring to FIG. 1, apparatus 100 may include a database. The database may include a remote database. The database may be implemented, without limitation, as a relational database, a key-value retrieval database such as a NOSQL database, or any other format or structure for use as database that a person skilled in the art would recognize as suitable upon review of the entirety of this disclosure. The database may alternatively or additionally be implemented using a distributed data storage protocol and/or data structure, such as a distributed hash table or the like. The database may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 1, apparatus 100 may include and/or be communicatively connected to a server, such as but not limited to, a remote server, a cloud server, a network server and the like. In one or more embodiments, the computing device may be configured to transmit one or more processes to be executed by server. In one or more embodiments, server may contain additional and/or increased processor power wherein one or more processes as described below may be performed by server. For example, and without limitation, one or more processes associated with machine learning may be performed by network server, wherein data is transmitted to server, processed and transmitted back to computing device. In one or more embodiments, server may be configured to perform one or more processes as described below to allow for increased computational power and/or decreased power usage by the apparatus computing device. In one or more embodiments, computing device may transmit processes to server wherein computing device may conserve power or energy.

Further referring to FIG. 1, apparatus 100 may include any “computing device” as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing devices operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting processor 102 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 102 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 102 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 102 is configured to receive container instructions 106 associated with at least a containerized module 108. As used in this disclosure, “container instructions” are executable commands, scripts, and/or configuration files that define the behavior, execution environment, and/or dependencies of a container. Container instructions 106 may specify how a containerized module 108 is built, deployed, and managed. In an embodiment, the container instructions 106 may include base images, software dependencies, runtime parameters, networking configurations, and/or file system structures. The container instructions 106 may be implemented using container orchestration frameworks, container runtime specifications, and/or container image definitions, such as those provided in a Dockerfile or Kubernetes manifest. As used in this disclosure, a “containerized module” is a self-contained software component encapsulated within a container. As used in this disclosure, a “container” is a standalone, executable software package that encapsulates an application, its dependencies, and the necessary runtime environment. In an embodiment, the container may provide consistent execution across different computing environments. Without limitation, the container may include application code, system libraries, configuration files, and other resources required for deployment and operation. Containers may enable modularization, scalability, and portability by isolating applications from the underlying system while maintaining compatibility across various platforms. In an embodiment, the container may include all necessary dependencies, runtime environments, and/or configurations required for execution. The containerized module 108 may be designed to be portable and scalable, enabling consistent deployment across various computing environments. The containerized module 108 may interact with other modules, services, or systems through defined interfaces and may be managed using container orchestration platforms to facilitate automated deployment, scaling, and lifecycle management. In a non-limiting example, processor 102 may receive container instructions 106 that specify the use of a Dockerfile to define a containerized module 108 for a web application. The container instructions 106 may include directives to pull a base image, install required dependencies such as a web server and/or a database client, and configure environment variables necessary for execution. In another non-limiting example, processor 102 may receive Kubernetes deployment YAML files as container instructions 106 to orchestrate a containerized module 108 representing a microservice. Without limitation, the container instructions 106 may define replica settings, resource allocation, networking configurations, and/or volume mounts to ensure the containerized module 108 operates efficiently within a distributed system. Without limitation, processor 102 may receive container instructions 106 in the form of a cloud-based container registry reference, where the container instructions 106 specify retrieving a pre-built containerized module 108 image, setting runtime constraints, and/or defining security policies before execution.

With continued reference to FIG. 1, the container instructions 106 may include at least the source code 110 of the at least a containerized module 108. As used in this disclosure, “source code” is a collection of human-readable instructions, written in scripting language, that defines the logic, functionality, and/or behavior of a software application. Without limitation, the source code 110 may include functions, classes, variables, conditional statements, loops, and/or other programming constructs that enable execution by a compiler and/or interpreter. The source code 110 may be stored in files, repositories, and/or version control systems, and it may be transformed into executable binaries, containerized modules 108, and/or deployable artifacts for use in various computing environments 150. In a non-limiting example, the container instructions 106 may include at least the source code 110 of a containerized module 108 written in Python, where the at least a source code 110 consists of application logic, function definitions, and/or configuration files necessary for execution within a containerized environment. The container instructions 106 may further specify dependencies using a requirements.txt file and/or an environment configuration file. In another non-limiting example, the container instructions 106 may include at least the source code 110 of at least a containerized module 108 developed in Java, where the at least a source code 110 comprises Java classes, package definitions, and/or build scripts such as a pom.xml file for Maven or a build.gradle file for Gradle. The container instructions 106 may specify runtime parameters and/or environment variables to be injected into the at least a containerized module 108 during execution.

With continued reference to FIG. 1, the at least a containerized module 108 may include an imaging task 112, wherein the imaging task 112 comprises generating, using at least an optical device 114, a first scan 116 of an object 118 at a first magnification 120, executing, using at least a processor 102, a region of interest detection algorithm 122 on the first scan 116 to determine at least a first parameter, configuring the at least an optical device using the at least a first parameter, generating, using the at least an optical device 114, a second scan 124 as a function of a detected region of interest 126 of the first scan 116 at a second magnification 128, and comparing, using an analysis algorithm 130, the second scan 124 to a plurality of high magnification images 132. As used in this disclosure, an “imaging task” is a process that involves capturing, processing, analyzing, and/or generating images using computational techniques. The imaging task 112 may include operations such as image acquisition, enhancement, segmentation, classification, and/or transformation to extract meaningful information or produce visual representations. The imaging task 112 may be performed using hardware components such as cameras, sensors, and/or scanners, as well as software-based algorithms for image recognition, reconstruction, and/or manipulation. The imaging task 112 may be applied in various domains, including medical imaging, remote sensing, computer vision, and/or autonomous systems.

With continued reference to FIG. 1, as used in this disclosure, an “optical device” is an instrument designed to manipulate, manage, or analyze light. In a non-limiting example, optical device 114 may include components such as lenses, mirrors, filters, gratings, or detectors, and is used in applications ranging from vision correction to the analysis of light properties. In a non-limiting example, optical device 114 may be one or more scanning devices. In a non-limiting example, processor 102 may receive scanned images and/or feedback directly from optical device 114 that scanned a microscope slide. In some cases, optical device 114 may include devices or systems used to digitize slides containing biomedical specimens (e.g., tissue samples). As a non-limiting example, optical device 114 may include digital cameras, digital microscopes, digital pathology scanners, or the like). In some cases, processor 102 may select parameters associated with optical device 114 such as, without limitation, magnification level, focus settings, scanning pattern, or the like. Additional disclosure related to optical device 114 and slide digitization process may be found in U.S. Patent Application No. 63/466,950, filed on May 16, 2023, entitled “SYSTEMS AND METHODS FOR INLINE QUALITY CONTROL OF SLIDE DIGITIZATION,” having an attorney docket number of 1519-029USP1, which is incorporated herein by reference in its entirety. Additional disclosure related to optical device 114 and slide digitization process may be found in U.S. patent application Ser. No. 18/602,947, filed on Mar. 12, 2024, entitled “SYSTEMS AND METHODS FOR INLINE QUALITY CONTROL OF SLIDE DIGITIZATION,” having an attorney docket number of 1519-029USU1, which is incorporated herein by reference in its entirety.

With continued reference to FIG. 1, as used in this disclosure, a “scan” is a process of capturing data from an object 118 using hardware and/or software. The scan may involve acquiring images, measuring signals, extracting information, and/or mapping structures for further processing. Without limitation, the scan may be performed using devices such as cameras, sensors, LiDAR systems, optical devices 114, medical imaging equipment, and the like.

With continued reference to FIG. 1, as used in this disclosure, a “magnification” is a process of enlarging an object 118, image, scan, and/or data representation to facilitate detailed observation and/or analysis. The magnification may be achieved through optical, digital, and/or computational techniques using lenses, microscopes, software algorithms, and/or imaging systems. In a non-limiting example, the magnification may be applied in a digital pathology system, where high-resolution microscope images of tissue samples are digitally magnified to enable pathologists to examine cellular structures and/or detect abnormalities such as cancerous cells. The magnification may be achieved using optical zoom lenses and/or computational image scaling techniques.

With continued reference to FIG. 1, as used in this disclosure, an “object” is a distinct physical entity. The object 118 may have specific properties, attributes, and/or characteristics that define its structure, behavior, and/or functionality. The object 118 may exist in various forms, including tangible items, such as mechanical components, biological specimens, and/or electronic devices, as well as digital representations, such as data structures, images, and/or virtual models. The object 118 may be detected, analyzed, classified, and/or transformed using imaging systems, computational algorithms, and/or sensor-based technologies. In a non-limiting example, the object 118 may be a microscope slide containing a biological specimen, where an imaging system captures high-resolution images of the slide for medical diagnosis and/or research analysis. The object 118 may contain tissue samples, blood smears, and/or bacterial cultures, which may be examined under different levels of magnification to identify cellular structures and/or detect abnormalities. In another non-limiting example, the object 118 may be a glass slide used in a digital pathology workflow, where an automated scanning system acquires digital images of the slide and/or processes the images using artificial intelligence to assist pathologists in identifying diseases. The object 118 may be labeled with barcodes and/or metadata to enable efficient tracking and/or integration with laboratory information systems. Without limitation, the object 118 may be an optical calibration slide used in an imaging device, where the slide contains predefined patterns and/or reference markers to calibrate magnification levels, adjust focus, and/or verify the accuracy of an imaging system before analyzing other samples.

With continued reference to FIG. 1, as used in this disclosure, a “region of interest detection algorithm” is a computational method designed to identify and/or extract areas within a scan. The region of interest detection algorithm 122 may utilize image processing techniques, machine learning models 162, and/or statistical methods to detect patterns, edges, features, and/or anomalies within a defined area. As used in this disclosure, a “detected region of interest” is an area within the scan identified and/or extracted by a region of interest detection algorithm 122. In an embodiment, the detected area of interest may be identified based on predefined criteria, such as feature intensity, texture patterns, object boundaries, and/or statistical significance. The detected region of interest 126 may contain relevant information for further processing, classification, and/or analysis in applications such as medical imaging, object recognition, remote sensing, and/or defect detection. The detected region of interest 126 may be represented using bounding boxes, segmentation masks, coordinates, and/or heatmaps to facilitate visualization 172 and/or computational processing.

With continued reference to FIG. 1, as used in this disclosure, an “analysis algorithm” is a computational method designed to process scans. The analysis algorithm 130 may utilize techniques such as statistical analysis, machine learning, image processing, and/or signal processing to analyze structured and/or unstructured data. Statistical analysis may be used to generate a recommendation by identifying patterns and correlations within scan data. In an embodiment, the analysis algorithm 130 may apply statistical methods to compare a newly captured scan to a database of previously analyzed high magnification images. For example, without limitation the analysis algorithm 130 may extract key features from the scan, such as texture, edge sharpness, or intensity distribution, and compute statistical metrics such as mean, variance, or standard deviation. The analysis algorithm 130 may then perform a similarity analysis, such as principal component analysis (PCA) or a clustering method like k-means, to determine how closely the new scan matches known categories of images. If the statistical analysis detects a significant deviation from expected patterns, the evaluation model 154 may generate a recommendation datum 158 to adjust scanning parameters, such as increasing resolution, modifying contrast settings, or re-scanning a specific region of interest. The recommendation datum 158 may also include identifying an optimal reference image from the high magnification dataset to guide further analysis or adjustments. The analysis algorithm 130 may be applied in various domains, including medical diagnostics, quality control, anomaly detection, and the like. As used in this disclosure, “high magnification images” are images captured at high levels of magnification to reveal fine details and/or features that may not be visible at lower magnifications. The plurality of high magnification images 132 may be obtained using optical microscopes, electron microscopes, digital zoom techniques, and/or computational image enhancement methods.

With continued reference to FIG. 1, the at least a containerized module 108 may include an obfuscation task 134, wherein the obfuscation task 134 comprises receiving, using the at least a processor 102, an input image 136 comprising at least an identification 138, executing, using the at least a processor 102, an obfuscation algorithm 140 on the input image 136, and generating, using the at least a processor 102, obfuscated image 142 as a function of the obfuscation algorithm 140. As used in this disclosure, an “obfuscation task” is a process that involves transforming data to obscure its identifiable characteristics while maintaining functionality. The obfuscation task 134 may be applied to source code 110, textual information, images, signals, and the like. In an embodiment, the obfuscation task 134 may include using an obfuscation algorithm 140 which may include techniques such as encryption, masking, scrambling, pixelation, noise injection, and the like as described in more detail below. The obfuscation task 134 may be used to prevent unauthorized access, maintain confidentiality, reduce the risk of data exploitation, and the like. As used in this disclosure, an “input image” is data provided to a system for processing. The input image 136 may be received from various sources, including user interactions, sensors, files, databases, network communications, and the like. The input image 136 may be in different formats, such as numerical values, text, images, audio, structured and/or unstructured data. As used in this disclosure, an “identification” is a process of distinguishing data based on attributes. For example, a patient name, date of birth, social security number, and the like may be an identification 138 of a patient. As used in this disclosure, an “obfuscation algorithm” is a computational method designed to transform data and obscure its original characteristics while maintaining functionality. The obfuscation algorithm 140 may apply techniques such as encryption, masking, scrambling, tokenization, pixelation, and/or noise injection to protect sensitive information, prevent unauthorized access, and/or hinder reverse engineering. As used in this disclosure, “obfuscated image” is data that is transformed using an obfuscation algorithm 140 to obscure its original identifiable characteristics while maintaining its function. In a non-limiting example, the at least a containerized module 108 may include an obfuscation task 134 applied to medical records for patient privacy protection. The obfuscation task 134 may receive, using the at least a processor 102, an input image 136 comprising at least an identification 138, such as a patient's name, medical record number, and/or date of birth. The at least a processor 102 may then execute an obfuscation algorithm 140 that applies de-identification techniques such as tokenization, data masking, and/or pseudonymization to replace or obscure personally identifiable information. Without limitation, the obfuscation algorithm 140 may transform the patient's name into a randomly generated identifier, mask portions of the medical record number, by replacing digits with asterisks, and/or substitute the date of birth with an age range. The at least a processor 102 may then generate obfuscated image 142 as a function of the obfuscation algorithm 140, ensuring that the medical records can still be used for research, analytics, and/or machine learning training while maintaining patient confidentiality in compliance with data protection regulations such as HIPAA and/or GDPR. In a non-limiting example, obfuscated image 142 in medical records may include replacing a patient's full name with a randomly generated alphanumeric identifier, such as changing “John Doe” to “Patient_8347XQ”, ensuring that the individual cannot be directly identified. In another non-limiting example, a medical record number “MRN-456789123” may be partially masked using an obfuscation algorithm 140, resulting in “MRN-8889123”, where only a portion of the number remains visible for reference while concealing sensitive details. Without limitation, a patient's date of birth “May 12, 1985” may be transformed into an age range, such as “35-40 years”, to retain relevant medical context while preventing exact identification. Without limitation, addresses may be generalized by replacing “1234 Elm Street, Springfield, IL” with “Springfield, IL”, ensuring geographic anonymity while preserving regional information useful for epidemiological studies. In another non-limiting example, the obfuscation algorithm 140 may be applied to free-text clinical notes by replacing direct identifiers with placeholders. For instance, without limitation, the text “Patient John Doe was admitted to Springfield General Hospital for a routine checkup.” may be transformed into “Patient [ID-8347] was admitted to [Hospital-XYZ] for a routine checkup.”, ensuring privacy while maintaining the record's usability for research and analysis.

With continued reference to FIG. 1, the at least a containerized module 108 may include a container system 144, wherein the container system 144 is configured to encapsulate container instructions 146, deploy, using the container instructions 146, container operations 148 across computing environments 150, and execute, using the container instructions 146, the container operations 148 across computing environments 150. As used in this disclosure, a “container system” is a lightweight and self-sufficient software unit that encapsulates an application along with its dependencies, runtime environment, configurations, and/or libraries to ensure consistent execution across different computing environments 150. The container system 144 is based on an isolated filesystem and/or utilizes containerization technology to enable process-level virtualization without requiring a full virtual machine. The container system 144 may be created, deployed, and/or managed using container orchestration platforms and/or command-line tools, allowing for scalable, efficient, and/or reproducible application execution in cloud, on-premises, and/or hybrid environments. In an embodiment, the containerized execution environment 144 may include a DOCKER® container, wherein the DOCKER container encapsulates DOCKER instructions to facilitate the deployment and execution of containerized workloads across multiple computing environments. As used in this disclosure, “container instructions” are directives used to define a container system 144. In an embodiment, the container instructions 146 may be directives and/or commands within a Dockerfile. The container instructions 146 may specify how to build a container image, including selecting a base image, copying files, installing dependencies, setting environment variables, configuring networking, and/or defining execution parameters. The container instructions 146 may include, without limitation, commands such as FROM to specify a base image, RUN to execute installation scripts, COPY to transfer files, EXPOSE to define ports, and/or CMD to specify the default execution command for the container. The container instructions 146 may enable the automation, reproducibility, and/or portability of containerized applications across different computing environments 150. As used in this disclosure, “container operations” are actions performed to manage and execute the container systems 144 within a containerized environment. The container operations 148 may include, without limitation, building a container image using docker build, running a container using docker run, managing container lifecycles with docker start, docker stop, and/or docker restart, and/or orchestrating multiple containers using Docker Compose or Kubernetes. The container operations 148 may further involve monitoring, logging, networking, volume management, and/or security configurations to ensure efficient container execution across various computing environments 150. As used in this disclosure, “computing environments” are physical and/or virtual infrastructures where computational processes are managed and deployed. The computing environments 150 may include, without limitation, local machines, cloud-based platforms, data centers, edge computing systems, virtualized servers, containerized infrastructures, and the like. The computing environments 150 may provide resources such as processing power, memory, storage, networking to support software execution, data processing, distributed computing tasks, and the like.

Still referring to FIG. 1, processor 102 is configured to deploy, using the container instructions 106, the at least a containerized module 108 within a containerized environment 1 52, wherein the at least a processor 102 instantiates the containerized environment 152. As used in this disclosure, a “containerized environment” is a computing environment configured to support the management of containerized modules. The containerized environment 152 may provide an isolated runtime for containers, ensuring that each containerized module operates with its designated dependencies, system resources, and configurations. The containerized environment 152 may be instantiated on a host operating system, within a cloud-based infrastructure, or on a bare-metal system, and may include orchestration tools, networking capabilities, and resource management functionalities to facilitate scalable and efficient container execution.

With continued reference to FIG. 1, the containerized environment 152 may include a virtual environment. As used in this disclosure, a “virtual environment” is a simulated computing environment that abstracts and/or isolates system resources to enable the execution of applications independently from the underlying hardware or operating system. The containerized environment 152 may be created using virtualization technologies, containerization platforms, and/or software-defined infrastructure to provide flexible, scalable, and/or portable computing capabilities. The containerized environment 152 may include, without limitation, virtual machines, containerized applications, cloud-based instances, and/or sandboxed execution environments to support software development, testing, deployment, and/or security isolation. Virtualization technologies enable the creation of virtual machines (VMs) by abstracting physical hardware resources and allocating them to multiple isolated environments. These technologies typically use a hypervisor (such as VMware ESXi, Microsoft Hyper-V, or KVM) to manage VMs, allowing multiple operating systems to run concurrently on a single physical server. Virtualization improves resource utilization, scalability, and flexibility in IT infrastructure. Containerization platforms, such as Docker, Kubernetes, and Podman, provide lightweight, portable, and isolated runtime environments for applications. Unlike VMs, containers share the host OS kernel but maintain separate file systems, dependencies, and execution environments. This allows for faster deployment, reduced overhead, and enhanced scalability, making containerization ideal for microservices architectures and cloud-native applications. In a non-limiting example, software-defined infrastructure is the abstraction and automation of computing resources, including compute, storage, and/or networking, through software-defined technologies. Without limitation, software-defined networking (SDN) may utilize software controllers to dynamically manage network traffic, enabling flexible and efficient data flow, as used in technologies such as Cisco ACI and/or OpenFlow. Additionally and or alternatively, software-defined storage (SDS) may decouple storage management from physical hardware, providing scalable and adaptable storage solutions, such as those implemented using Ceph and/or VMware vSAN. Continuing, software-defined compute may leverage virtualization and/or container orchestration to dynamically allocate compute resources based on workload demands, optimizing resource utilization and system efficiency.

Still referring to FIG. 1, processor 102 is configured to validate, using an evaluation model 154, a compatibility datum 156 of the at least a containerized module 108. As used in this disclosure, an “evaluation model” is a computational framework and/or algorithm designed to assess the performance of a system. The evaluation model 154 may utilize predefined criteria, metrics, and/or benchmarks to generate assessments, comparisons, and/or predictive insights. Without limitation, the evaluation model 154 may use one or more machine learning models 162 to facilitate decision-making, optimization, validation of results of the apparatus 100, and the like. The evaluation model 154 may incorporate statistical analysis, rule-based logic, artificial intelligence, and/or heuristic techniques to enhance the accuracy and reliability of evaluations. As used in this disclosure, a “compatibility datum” is a data element, parameter, and/or attribute that defines, represents, and/or evaluates the degree of compatibility between two or more system components, interfaces, and/or data structures. The compatibility datum 156 may be used to assess whether input data, formats, and/or operational parameters 184 align with the expected requirements of a receiving module, process, and/or system. Without limitation, the compatibility datum 156 may include data type specifications, format constraints, protocol definitions, and/or transformation rules that facilitate interoperability, conversion, and/or integration between connected components. In an embodiment, the evaluation model 154 may utilize the compatibility datum 156 to analyze the interaction between two connected components. Without limitation, the evaluation model 154 may evaluate the data being provided as input to the at least a containerized module 108 and the expected input format, structure, and/or parameters 184 required by the at least a containerized module 108 for proper execution. Continuing, if discrepancies are identified, the evaluation model 154 may suggest a recommendation datum 158 that transforms the input data into a format that meets the requirements of the at least a containerized module 108 as described in more detail below. Additionally and/or alternatively, the evaluation model 154 may suggest, through a recommendation datum 158, the creation of a required parameter that is missing in the at least a containerized model but necessary for ensuring seamless data processing and system functionality across the apparatus 100. In an embodiment, the evaluation model 154 may generate a recommendation datum 158 that suggests the inclusion of a module capable of generating a required parameter that is missing from the at least a containerized module 108 but necessary for seamless data processing. The suggested module may, for example, synthesize default values, retrieve missing data from an external source, or compute necessary parameters dynamically to maintain system functionality across the apparatus 100.

With continued reference to FIG. 1, validating the compatibility datum 156 of the at least a containerized module 108 may include identifying, using the evaluation model 154, an error 160 associated with an input format of the at least a containerized module 108, determining a transformation required to resolve the error 160, and generating, using the evaluation model 154, a recommendation datum 158 to apply the transformation. As used in this disclosure, a “recommendation datum” is a data element, parameter, and/or output generated by the evaluation model 154 to suggest modifications and/or corrective actions to facilitate integration of the at least a containerized module 108 with the apparatus 100. Without limitation, the recommendation datum 158 may be based on an analysis of input-output relationships, system constraints, and/or optimization criteria. In an embodiment, the recommendation datum 158 may include suggested parameter adjustments, format conversions, and/or alternative module selections to enhance system interoperability. As used in this disclosure, an “error” is a discrepancy between a required system behavior and the actual observed operation. The error 160 may result from incompatibility between connected components, incorrect data structures, missing parameters 184, and/or processing failures. Without limitation, the error 160 may be identified through validation, testing, and/or execution analysis and may be used to trigger corrective actions, adjustments, and/or optimizations within a system. In an embodiment, validating the compatibility datum 156 of the at least a containerized module 108 may involve utilizing the evaluation model 154 to analyze the errors 160 between expected and actual input-output behaviors. If the error 160 is detected, the evaluation model 154 may generate a recommendation datum 158, which may suggest modifying input data, applying a transformation module, and/or adjusting system parameters 184 to resolve the detected error 160 and improve compatibility between components.

With continued reference to FIG. 1, as used in this disclosure, an “input format” is a defined configuration of data that a containerized module is designed to accept as input. The input format may specify parameters such as data type, encoding, schema, or required attributes necessary for successful execution within the module. In an embodiment, the evaluation model 108 may identify an error 160 associated with an input format by detecting a mismatch between the provided data structure and the expected schema of the at least a containerized module 108. For example, if the at least a containerized module 108 requires a JSON object with specific key-value pairs but receives an XML-formatted input, the evaluation model 154 may generate a recommendation datum 158 to apply a transformation that converts the XML data into the required JSON structure. The recommendation datum 158 may include specific mapping instructions or suggest an intermediary module that performs the necessary conversion.

With continued reference to FIG. 1, as used in this disclosure, a “transformation” is a conversion of data from one type to another. In an embodiment, the transformation may ensure compatibility with the input format of the at least a containerized module 108. The transformation may include operations such as data type conversion, schema mapping, value normalization, or parameter augmentation to resolve identified errors and enable seamless processing by the at least a containerized module 108. In an embodiment, the evaluation model 154 may determine that a transformation is required to modify a numerical parameter to align with the expected range or precision of the at least a containerized module 108. For instance, if the at least a containerized module 108 expects temperature data in Celsius but receives values in Fahrenheit, the evaluation model 154 may generate a recommendation datum 158 to apply a mathematical transformation to convert the input values accordingly. The transformation may involve a predefined formula or an external data processing module capable of performing unit conversions before passing the data to the at least a containerized module 108.

With continued reference to FIG. 1, the evaluation module may include a machine learning model 162 trained using a recommendation training dataset 164, wherein the recommendation training dataset 164 comprises historical recommendations 166 associated with historical errors 168. As used in this disclosure, a “recommendation training dataset” is a collection of data used to train a machine learning model 162 to generate a recommendation datum 158. In an embodiment, the recommendation training dataset 164 may include past recommendations generated by the evaluation model 154 for previous errors identified by the evaluation model 154. The recommendation training dataset 164 may provide input-output relationships, transformation rules, and/or decision-making patterns that enable the machine learning model 162 to generate improved recommendations in future scenarios. As used in this disclosure, “historical recommendations” are previously generated corrective actions that were used to resolve errors of the at least a containerized module 108. The historical recommendations 166 may include adjustments to input parameters 184, transformations between data formats, and/or the selection of alternative modules to optimize functionality. As used in this disclosure, “historical errors” are past discrepancies between expected outcomes and actual results. The historical errors 168 may provide context for generating corrective actions, refining validation processes, and/or improving the accuracy of future recommendations. In a non-limiting example, the recommendation training dataset 164 may include historical errors 168 where a containerized module 108 expected a JSON-formatted input, but the provided input was in XML format. The corresponding historical recommendations 166 may include applying a transformation module that converts XML to JSON before passing it to the at least a containerized module 108. Without limitation, by training the evaluation model 154 on the recommendation training dataset 164, the machine learning model 162 may learn to automatically suggest, using the recommendation datum 158, format conversion whenever it detects similar input-output mismatches in future validation scenarios. In another non-limiting example, the historical errors 168 may include instances where the at least a containerized module 108 required an authentication token as an input parameter, but the provided input lacked the required token. The historical recommendations 166 may include modifying system configurations to generate and attach authentication tokens automatically. The machine learning model 162, trained on this recommendation training dataset 164, may learn to suggest similar corrective actions whenever it detects missing authentication parameters 184 in new validation cases. Without limitation, the recommendation training dataset 164 may contain historical errors 168 related to data size mismatches, such as cases where a module accepted a maximum payload size of 5 MB, but an incoming request contained a 10 MB file. The corresponding historical recommendations 166 may involve compressing the file or splitting it into smaller chunks before processing. Continuing, by analyzing such historical relationships, the machine learning model 162 may improve its ability to recommend efficient solutions when validating the compatibility of containerized modules 108.

Still referring to FIG. 1, processor 102 is configured to displaying, using a graphical user interface 170, a visualization 172 of a process sequence, wherein the visualization 172 comprises a first visual element 176 of a plurality of visual elements, wherein the first visual element 176 is associated with the at least a containerized module 108, the first visual element 176 connected to a second visual element 178 associated with a second containerized module 180, and a third visual element 182 associated with at least a parameter 184 of the at least a containerized module 108. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface 170. For example, links to decentralized platforms as described in this disclosure may be incorporated using icons. Using an icon may be a fast way to open documents, run programs etc. because clicking on them yields instant access. In an embodiment, the graphical user interface 170 and an event handler may operate together to enable seamless interaction between the user and the apparatus 100. The GUI serves as the visual and interactive layer through which the user engages with the apparatus 100, presenting elements such as buttons, sliders, input fields, and informational displays. The event handler, on the other hand, functions as the underlying mechanism that monitors and responds to user interactions with the GUI. For example, when a user clicks a button on the GUI to request an explanation of a concept, the event handler may detect the click event, identify its context, and trigger the appropriate processes within the apparatus 100 to generate a tailored response. This interplay may ensure dynamic and responsive system behavior, as the event handler processes various input events such as clicks, taps, keystrokes, or voice commands, and relays these inputs to the relevant system components. The GUI subsequently updates to reflect the system's responses, such as displaying user-specific output, modifying visual elements, or providing real-time feedback. Together, the GUI and event handler create an intuitive and interactive experience, bridging user actions and system functionality to achieve efficient and personalized outcomes. An “event handler,” as used in this disclosure, is a module, data structure, function, and/or routine that performs an action in response to an event. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler may generate prompts for further information, may compare data to validation rules such as requirements that the data in question be entered within certain numerical ranges, and/or may modify data and/or generate warnings to a user in response to such requirements. As used in this disclosure, a “visual element” is a component or feature within a system, display, or interface that conveys information through visual means. In a non-limiting example, the visual element may include text, images, icons, shapes, colors, and/or other graphical components designed to be perceived by the user. In a non-limiting example, the visual element may aid in communication, navigation, and/or interaction with the system. Without limitation, the visual element may be used to enhance user experience, guide behavior, and/or represent data visually in an intuitive or informative way. A visual element may include data transmitted to display device, client device, and/or graphical user interface 170. In some embodiments, visual element may be interacted with. For example, visual element may include an interface, such as a button or menu. In some embodiments, visual element may be interacted with using a user device such as a smartphone, tablet, smartwatch, or computer. In an embodiment, the apparatus 100 and or the downstream device may include a data structure. With continued reference to FIG. 1, as used in this disclosure, “data structure” is a way of organizing data represented in a specialized format on a computer configured such that the information can be effectively presented in a graphical user interface 170. In some cases, the data structure includes any input data. In some cases, the data structure contains data and/or rules used to visualize the graphical elements within a graphical user interface 170. In some cases, the data structure may include any data described in this disclosure. In some cases, the data structure may be configured to modify the graphical user interface 170, wherein data within the data structure may be represented visually by the graphical user interface 170. In some cases, the data structure may be continuously modified and/or updated by processor 102, wherein elements within graphical user interface 170 may be modified as a result. In some cases, processor 102 may be configured to transmit display device and or the downstream device the data structure. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio, and microwave data and/or signals, combinations thereof, and the like, among others. Processor 102 may transmit the data described above to a database wherein the data may be accessed from the database. Processor 102 may further transmit the data above to a display device, client device, or another computing device. The data structure may serve as the organizational framework that stores, retrieves, and manages data required for processing events and updating the GUI. The data structure may act as a bridge between the user's input, captured by the event handler, and the output displayed on the GUI, ensuring that information is handled efficiently and accurately throughout the interaction. For example, without limitation, when a user interacts with a dropdown menu in the GUI to select a topic, the event handler may capture this input and accesses a data structure, such as a dictionary or tree, that maps each topic to its associated resources or actions. The data structure may retrieve the relevant information such as, text explanations, videos, or interactive exercises, and passes it back to the event handler, which may then trigger the appropriate updates to the GUI, such as displaying the selected topic's content. In another embodiment, the data structure may also maintain the state of the system, tracking user progress, preferences, and session history. For instance, without limitation, a hash table may store user specific configurations, such as preferred learning styles or recent activity, which the event handler references when processing interactions. The GUI may then dynamically adapt to display content aligned with these configurations. This integration may ensure that user inputs are seamlessly translated into meaningful system outputs, with the data structure enabling rapid access, consistency, and scalability throughout the process. As used in this disclosure, a “hash table” is a data structure that stores data in a way that allows for fast retrieval, insertion, and deletion of elements. The hash table may organize data into key-value pairs, where each key is unique and used to identify its corresponding value. A hash table may use a hash function to compute an index, or hash code, from the key, which determines where the key-value pair is stored within an array or list.

With continued reference to FIG. 1, as used in this disclosure, an “interactive element” is a component or feature within a graphical user interface 170 (GUI) that allows users to perform actions, provide input, or engage with the apparatus 100. Interactive elements may be designed to facilitate two-way communication between the user and the system, enabling the user to influence the behavior of the apparatus or obtain feedback in response to their actions. Examples of interactive elements may include buttons, dropdown menus, sliders, checkboxes, input fields, and hyperlinks. For instance, without limitation, a button labeled “Submit” may allow a user to send their input for processing, while a slider may let the user adjust settings, such as the magnification level of an imaging parameter. More advanced interactive elements may include drag-and-drop interfaces, interactive diagrams, or dynamically updating content areas that respond to user actions in real time. The interactive elements may enhance user engagement by providing intuitive and responsive mechanisms for interacting with the system. Interactive elements may operate by responding to user actions such as clicks, taps, swipes, or keyboard inputs, and triggering predefined system behaviors or processes. The execution of the interactive elements may require a combination of front-end and back-end technologies that work together to provide seamless functionality and user interaction. On the front end, technologies such as HTML and CSS may define the structure, appearance, and layout of the interactive elements, while JavaScript may enable dynamic functionality. For example, without limitation, JavaScript may detect when the user clicks a button and trigger actions or animations. Front-end frameworks like React, Angular, or Vue.js may further enhance development by offering reusable components and efficient rendering mechanisms. On the back end, the system may process the user's input, retrieve the necessary data, and communicate with the front end to provide an appropriate response. APIs may act as a bridge between the front end and back end, facilitating data transfer, such as sending a user's form submission to the server and retrieving processed results. Server-side logic, implemented using languages like Python, Java, or Node.js, may handle input processing and return relevant data, such as a user's profile or quiz questions. Additional supporting technologies may ensure the smooth operation of interactive elements. Event listeners, for instance, may continuously monitor for specific actions like mouse clicks or text entries, executing code when such events are detected. Efficient data structures, such as hash tables or dictionaries, may store interactive state data, such as user preferences or settings, for quick access and updates. Databases, including MySQL or MongoDB, may manage and store the data required for interactive features, such as user profiles or historical activity. Communication technologies may also help maintain the responsiveness of interactive elements. AJAX (Asynchronous JavaScript and XML) may allow the front end to update portions of a web page without requiring a full page reload, enhancing responsiveness. WebSockets may provide real-time interaction capabilities, such as live chats or collaborative tools, by enabling persistent communication between the client and the server.

Without limitation, the apparatus 100 may include one or more APIs. As used in this disclosure, an “application programming interface (API)” is a set of defined protocols, tools, and methods that allow different software applications, systems, or components to communicate and interact with each other. The API may act as an intermediary that enables a client application, such as a user-facing app, to send requests to a server or service and receive the necessary responses, facilitating seamless integration and functionality across diverse systems.

With continued reference to FIG. 1, as used in this disclosure, a “visualization” is a graphical representation of data or processes designed to enhance user interaction with the apparatus 100. The visualization 172 may include visual elements such as nodes, links, charts, and/or diagrams that illustrate relationships, workflows, and/or configurations in an intuitive manner. As used in this disclosure, a “process sequence” is an ordered arrangement of executing the at least a containerized module 108 that define a structured workflow within a system. The process sequence may represent the flow of data, control logic, and/or dependencies between the connected at least a containerized module 108, enabling systematic execution, tracking, and/or optimization of operations. As used in this disclosure, a “parameter” is a configurable value associated with the at least a containerized module 108 that influences its behavior, execution, and/or output. The parameter may define operational constraints, thresholds, and/or customization options that allow for flexibility and adaptation within a workflow. In an embodiment, the processor 102 may be configured to display a visualization 172 of a process sequence using a graphical user interface 170, where users can interact with the workflow by selecting at least a containerized module 108, visually connecting them, and configuring parameters 184. The visualization 172 may represent containerized modules 108 as visual elements, with connections indicating data flow or dependencies. Users may be able to set parameters 184 for each module, such as specifying input formats, adjusting computational thresholds, or enabling specific processing options to customize the workflow according to their requirements. In a non-limiting example, the processor 102 may be configured to display a visualization 172 within the graphical user interface 170, where a user builds a workflow for processing medical images by selecting and connecting containerized modules 108. The visualization 172 may represent the sequence of operations using drag-and-drop elements, where each of the at least a containerized modules 108 appear as a box or node connected by directional lines that indicate data flow. For instance, without limitation, the user may begin by selecting a first containerized module 108 responsible for an imaging task 112, such as image acquisition or enhancement. The at least a containerized module 108 may appear as a rectangle labeled “Imaging Module” with an input port for raw image data and an output port for processed images. The user may configure parameters 184 through a side panel or pop-up settings window, where they can specify the image resolution, magnification level, or preprocessing options such as contrast enhancement, noise reduction. Continuing, the user may visually connect this at least a containerized module 108 to a second containerized module 180 designed for an obfuscation task 134, ensuring that identifiable patient information is removed from the images. The second at least a containerized module 108 may be labeled “Obfuscation Module” and may include configuration options for selecting obfuscation methods, such as blurring patient identifiers, redacting metadata, or applying encryption. In a non-limiting example, the visualization 172 of the graphical user interface 170 may include a Module Library positioned on the left side, where users may browse and select available containerized modules 108 to drag onto the workflow canvas. The central workflow canvas may provide an interactive space where users may visually arrange modules and establish connections between them using click-and-drag connectors, allowing for the representation of data dependencies within the process sequence 174. Without limitation, a Properties Panel may be displayed on the right side, enabling users to configure module-specific parameters 184, such as selecting an obfuscation method or defining threshold values for image processing. Additionally and or alternatively, a toolbar may be provided, featuring buttons that allow users to execute various workflow actions. For example, a “Run Workflow” button may initiate the configured process sequence 174, while a “Validate” button may check for compatibility errors 160 between connected modules. Users may also have access to “Undo” and “Redo” options to modify the workflow design, as well as a “Save Template” button to store reusable workflow configurations for future use.

With continued reference to FIG. 1, in a non-limiting example, graphical user interface 170 may be consistent with one or more aspects of the “term” described in attorney docket number 1519-145USU1, U.S. patent application Ser. No. 18/647,138, filed on Apr. 26, 2024, titled “APPARATUS FOR CONTROL OF IMAGE PROCESSING ALGORITHMS IN A GRAPHICAL INTERFACE,” which is incorporated by reference herein in its entirety.

With continued reference to FIG. 1, in a non-limiting example, graphical user interface 170 may be consistent with one or more aspects of the “term” described in attorney docket number 1519-174USU1, U.S. patent application Ser. No. 18/660,007, filed on May 9, 2024, titled “SYSTEMS AND METHODS FOR AUGMENTED VISUALIZATION USING ACTIVITY WINDOWS,” which is incorporated by reference herein in its entirety.

Still referring to FIG. 1, processor 102 is configured to generate, using the at least a containerized module 108, an output 186 of the process sequence 174. As used in this disclosure, an “output” is a result generated by the at least a containerized module 108 in response to an input. The output 186 may be in the form of numerical values, text, images, signals, reports, and/or transformed datasets, depending on the function of executing at least a containerized module 108. The output 186 may be utilized for further processing, analysis, storage, and/or display within a computing environment. In an embodiment, the processor 102 may be configured to generate an output 186 using the at least a containerized module 108 within the process sequence 174. Without limitation, if the process sequence 174 includes an imaging module followed by an obfuscation module, the output 186 may be an obfuscated image where identifiable patient information has been removed. In another non-limiting example, if the process sequence 174 includes a data transformation module, the output 186 may be a reformatted dataset that aligns with the expected structure of a downstream system.

Still referring to FIG. 1, processor 102 is configured to display, using the graphical user interface 170, the output 186 of the process sequence 174. Without limitation, if the process sequence 174 includes a first containerized module that enhances an MRI scan by adjusting contrast and a second containerized module 180 that applies an obfuscation task 134 to remove patient identifiers, the output 186 may be a processed, de-identified MRI scan. The graphical user interface 170 may display the final obfuscated image in a preview window, allowing users to verify the modifications before saving or exporting the result. In another non-limiting example, if the process sequence 174 involves a data transformation module, where patient information is converted from an unstructured text format into a structured JSON format, the graphical user interface 170 may display a side-by-side comparison of the original text-based records and the transformed JSON output 186. Users may interact with the displayed output 186 by expanding collapsed sections, copying structured data, or exporting the result for further processing. Without limitation, if the output 186 includes analytical results, such as a machine learning-based anomaly detection report, the graphical user interface 170 may present the output 186 in a dashboard format, displaying key findings as charts, tables, and/or flagged alerts. Users may be able to filter results, adjust visualization 172 settings, or generate downloadable reports directly from the graphical user interface 170.

With continued reference to FIG. 1, the processor 102 may be further configured to generate a developer portal 188, wherein the developer portal 188 receives user input 190 and generates a third-party module 192 as a function of the user input 190. As used in this disclosure, a “developer portal” is a platform designed to provide entities with resources for building software modules. The developer portal 188 may include application programming interface (API) documentation, software development kits (SDKs), sample code, tutorials, testing environments 194, and/or validation tools to facilitate efficient development and deployment of software components. As used in this disclosure, a “user input” is information provided by a user to a system for processing, execution, and/or customization. The user input 190 may be received through text fields, dropdown menus, file uploads, code submissions, and/or interactive graphical elements. In an embodiment, the user input 190 may influence the behavior, functionality, and/or output 186 of the apparatus 100. As used in this disclosure, a “third-party module” is a software component developed externally from a primary system but integrated into it to extend functionality, enhance interoperability, and/or support customization. The third-party module 192 may be created by independent developers, external vendors, and/or open-source communities and may be accessed through APIs, SDKs, and/or plug-in architectures. Without limitation, the processor 102 may be configured to generate a developer portal 188, where users may provide user input 190, such as uploading source code 110, specifying dependencies, and/or configuring runtime parameters 184. As a function of the user input 190, the developer portal 188 may generate a third-party module 192, compiling and packaging the submitted code into a deployable containerized service that can integrate seamlessly within the system. The developer portal 188 may also offer tools for testing and validating the third-party module 192, ensuring compatibility and security before deployment.

With continued reference to FIG. 1, the developer portal 188 may include generating at least a testing environment 194, wherein the testing environment 194 is configured to execute the third-party module 192 in an isolated manner to evaluate one or more functions. As used in this disclosure, a “testing environment” is a controlled computing environment configured to execute, evaluate, and/or validate the functionality, performance, and/or security of a software module, system, and/or application before deployment. The testing environment 194 may simulate real-world conditions, provide debugging tools, and/or enable automated and/or manual testing processes to identify errors 160, incompatibilities, and/or performance issues. Without limitation, the testing environment 194 may include sandboxed execution spaces, virtualized infrastructures, and/or containerized instances to facilitate safe and repeatable testing scenarios. As used in this disclosure, “functions” are specific operations performed by a software module, system, and/or application to achieve a defined objective. The one or more functions may include, without limitation, data processing, computation, input-output handling, error detection, and/or interaction with other modules. The one or more functions may be evaluated in a testing environment 194 to verify correctness, efficiency, and/or compatibility before deployment. In an embodiment, the developer portal 188 may test, using the at least a testing environment 194, the third-party module 192 and/or the containerized module 108 in an isolated manner to evaluate one or more functions. Without limitation, the testing environment 194 may assess whether the third-party module 192 correctly processes input data, adheres to expected output 186 formats, and/or interacts seamlessly with other containerized services.

With continued reference to FIG. 1, wherein the at least a processor 102 may be further configured to retrieve, using a module repository, the third-party module 192, store, using the module repository, the third-party module 192, and distribute the third-party module 192. As used in this disclosure, a “module repository” is a centralized storage system configured to receive, store, manage, and/or distribute software modules. In an embodiment, the module repository may take the form of a database and/or version-controlled platform. In an embodiment, the module repository may include receiving, storing, managing, and/or distributing a containerized services, third-party extensions, and/or executable components. The module repository may facilitate secure access, version tracking, dependency management, and/or seamless integration of stored modules within a computing environment. Without limitation, the module repository may support automated updates, metadata indexing, and/or role-based access controls to ensure efficient module distribution and deployment. In a non-limiting example, the module repository may be implemented as a Docker registry, such as Docker Hub or Amazon Elastic Container Registry (ECR), where third-party modules 192 are stored as container images and can be pulled by users or systems for deployment in a containerized infrastructure. Continuing, the developer may upload a newly created module to the module repository, where it is assigned a unique tag corresponding to its version, enabling version control and traceability. In another non-limiting example, the module repository may be integrated within a cloud-based software marketplace, such as AWS Marketplace or Google Cloud Artifact Registry, where enterprises can store proprietary modules and/or distribute them to authorized users. A healthcare analytics company, for instance, may use the module repository to store AI-driven medical image processing modules, allowing hospitals to download and integrate them into their existing workflows. Without limitation, the module repository may be implemented as an internal enterprise repository, such as JFrog Artifactory or GitHub Packages, where development teams can collaboratively manage, test, and deploy reusable software components across multiple projects. In an embodiment, an organization developing microservices may use the module repository to store backend service modules to ensure consistency and reusability across different teams and environments.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

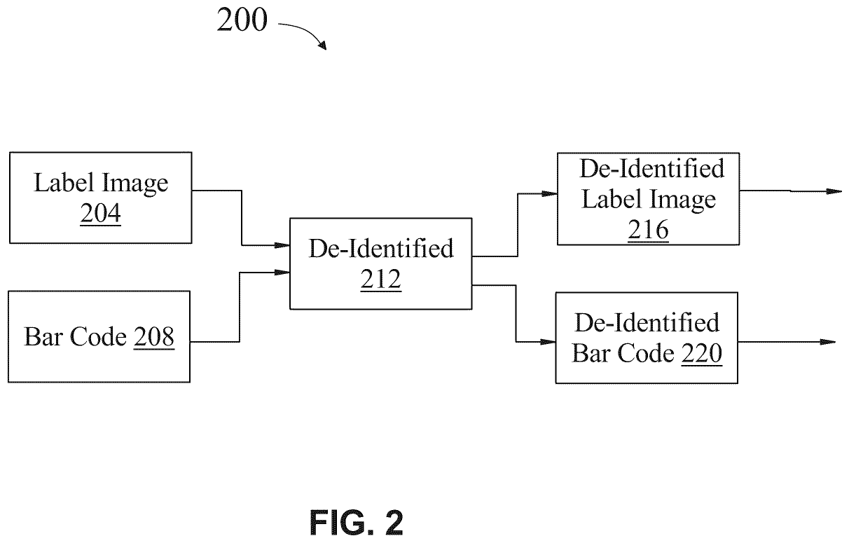

Referring now to FIG. 2, an exemplary illustration of at least a containerized module 200 comprising an obfuscation task. In an embodiment, the at least a containerized module 200 includes a label image 204 as input. In an embodiment, the at least a containerized module 200 includes a bar code 208 as input. In an embodiment, the at least a containerized module 200 includes a de-identified model 212. In an embodiment, the de-identified model 212 receives the label image 204 and/or the bar code 208. In an embodiment, the de-identified model 212 generates output, wherein the output includes de-identified label image 216. In an embodiment, the de-identified model 212 generates output, wherein the output includes de-identified bar code 220.

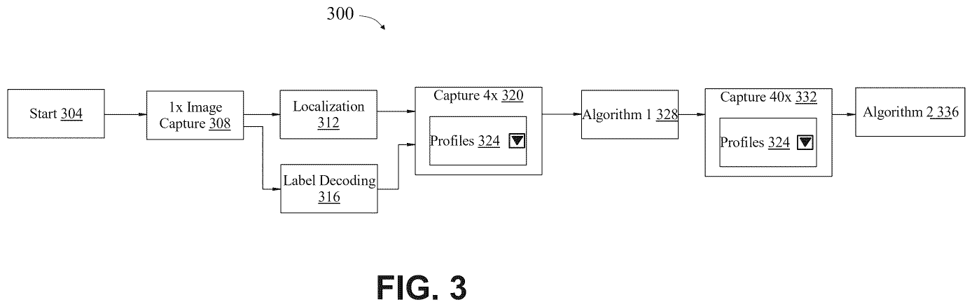

Referring now to FIG. 3, an exemplary illustration of at least a containerized module 300 comprising an imaging task. In an embodiment, the at least a containerized module 300 includes a start 304. In an embodiment, the at least a containerized module 300 includes a 1× image capture 308 after the start 304. In an embodiment, the 1× image capture 308 is fed into the localization 312 and/or the label decoding 316. In an embodiment, the at least a containerized module 300 may then capture 4× the magnification 320 of the 1× image capture 308. In an embodiment, the capture 4× 320 includes profiles 324. In an embodiment, the next step of the at least a containerized module 300 includes feeding the capture 4× 320 into an 328. In an embodiment, the next step of the at least a containerized module 300 includes capture 40× 332. In an embodiment, the capture 40× 332 includes profiles 324. In an embodiment, the capture 40× is fed into the algorithm 2 336.

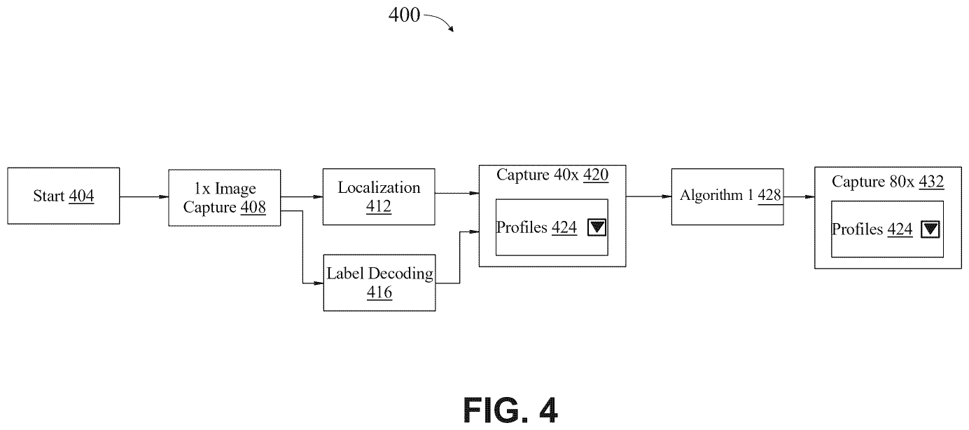

Referring now to FIG. 4 is an exemplary illustration of at least a containerized module 400 comprising a workflow execution. In an embodiment, the at least a containerized module 400 includes a start 404. In an embodiment the at least a containerized module 400 includes a 1× image capture 408. In an embodiment, the next step of the at least a containerized module 400 includes feeding the 1× image capture 408 into a localization 412 and/or a label decoding module 416. In an embodiment, the at least a containerized module 400 includes capture 40× 420 that receives the output from the localization 412 and/or the label decoding 416. In an embodiment, the capture 40× 420 includes profiles 424. In an embodiment, the at least a containerized module 400 includes an 428 that receives the output from the capture 40× 420. In an embodiment, the 428 outputs capture 80× 432. In an embodiment, the capture 80× 432 includes profiles 424.

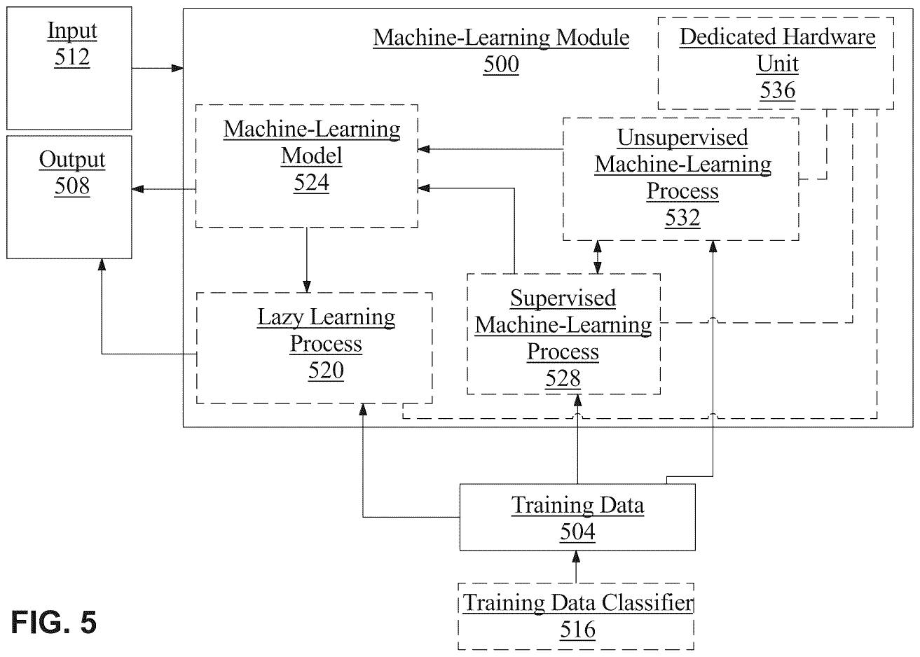

Referring now to FIG. 5, an exemplary embodiment of a machine-learning module 500 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 504 to generate an algorithm instantiated in hardware or software logic, data structures, and/or functions that will be performed by a computing device/module to produce outputs 508 given data provided as inputs 512; this is in contrast to a non-machine learning software program where the commands to be executed are determined in advance by a user and written in a programming language.

Still referring to FIG. 5, “training data,” as used herein, is data containing correlations that a machine-learning process may use to model relationships between two or more categories of data elements. For instance, and without limitation, training data 504 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 504 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 504 according to various correlations; correlations may indicate causative and/or predictive links between categories of data elements, which may be modeled as relationships such as mathematical relationships by machine-learning processes as described in further detail below. Training data 504 may be formatted and/or organized by categories of data elements, for instance by associating data elements with one or more descriptors corresponding to categories of data elements. As a non-limiting example, training data 504 may include data entered in standardized forms by persons or processes, such that entry of a given data element in a given field in a form may be mapped to one or more descriptors of categories. Elements in training data 504 may be linked to descriptors of categories by tags, tokens, or other data elements; for instance, and without limitation, training data 504 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 5, training data 504 may include one or more elements that are not categorized; that is, training data 504 may not be formatted or contain descriptors for some elements of data. Machine-learning algorithms and/or other processes may sort training data 504 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 504 to be made applicable for two or more distinct machine-learning algorithms as described in further detail below. Training data 504 used by machine-learning module 500 may correlate any input data as described in this disclosure to any output data as described in this disclosure. As a non-limiting illustrative example compatibility data between connected containerized modules, such as expected input formats, required parameters, and historical errors encountered during validation.

Further referring to FIG. 5, training data may be filtered, sorted, and/or selected using one or more supervised and/or unsupervised machine-learning processes and/or models as described in further detail below; such models may include without limitation a training data classifier 516. Training data classifier 516 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 500 may generate a classifier using a classification algorithm, defined as a processes whereby a computing device and/or any module and/or component operating thereon derives a classifier from training data 504. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 516 may classify elements of training data into groups representing frequently occurring validation issues, such as mismatched data formats, missing authentication tokens, and/or computational resource constraints, allowing the evaluation module to refine its recommendation model and optimize system performance.

Still referring to FIG. 5, Computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. Computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 5, Computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 5, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 5, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 5, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 5, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 5, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 5, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 5, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 5, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 5, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{min}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25th percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Still referring to FIG. 5, machine-learning module 500 may be configured to perform a lazy-learning process 520 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 504. Heuristic may include selecting some number of highest-ranking associations and/or training data 504 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 5, machine-learning processes as described in this disclosure may be used to generate machine-learning models 524. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 524 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 524 may be generated by creating an artificial neural network, such as a convolutional neural network comprising an input layer of nodes, one or more intermediate layers, and an output layer of nodes. Connections between nodes may be created via the process of “training” the network, in which elements from a training data 504 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 5, machine-learning algorithms may include at least a supervised machine-learning process 528. At least a supervised machine-learning process 528, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include compatibility data between connected containerized modules, such as expected input formats, required parameters as described above as inputs, historical errors encountered during validation as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 504. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

With further reference to FIG. 5, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 5, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 5, machine learning processes may include at least an unsupervised machine-learning processes 532. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 532 may not require a response variable; unsupervised processes 532 may be used to find interesting patterns and/or inferences between variables, to determine a degree of correlation between two or more variables, or the like.

Still referring to FIG. 5, machine-learning module 500 may be designed and configured to create a machine-learning model 524 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 5, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 5, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 5, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 5, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 5, one or more processes or algorithms described above may be performed by at least a dedicated hardware unit 536. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 536 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 536 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 536 to perform one or more operations described herein, such as evaluation of model and/or algorithm outputs, one-time or iterative updates to parameters, coefficients, weights, and/or biases, and/or any other operations such as vector and/or matrix operations as described in this disclosure.

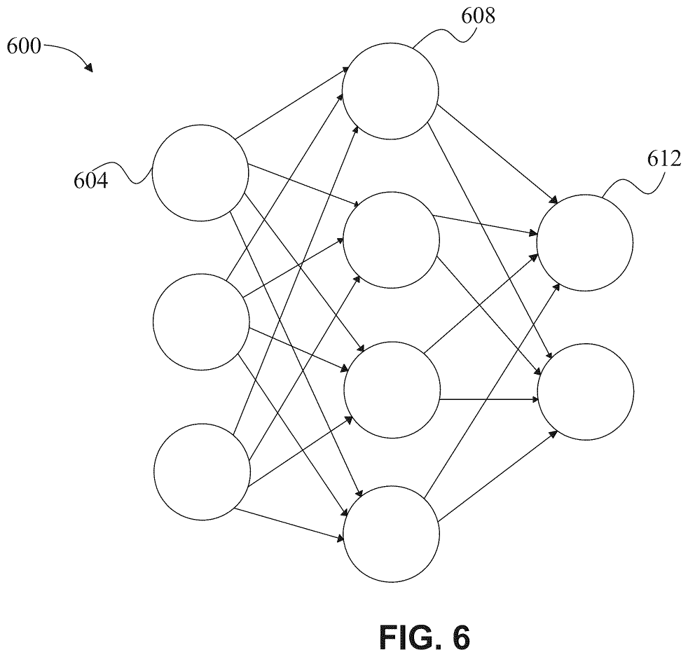

Referring now to FIG. 6, an exemplary embodiment of neural network 600 is illustrated. A neural network 600 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 604, one or more intermediate layers 608, and an output layer of nodes 612. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

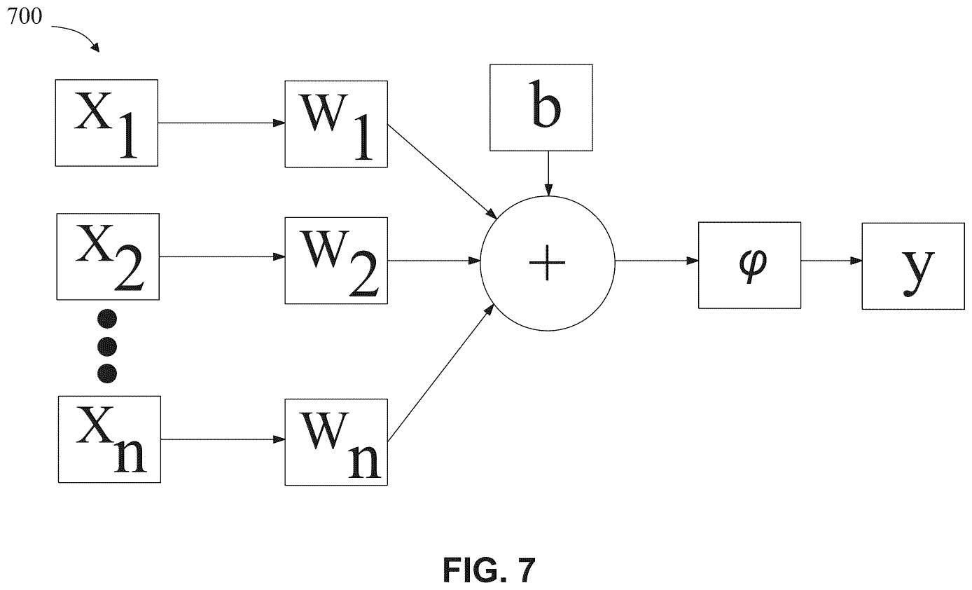

Referring now to FIG. 7, an exemplary embodiment of a node 700 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a (1+tanh (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

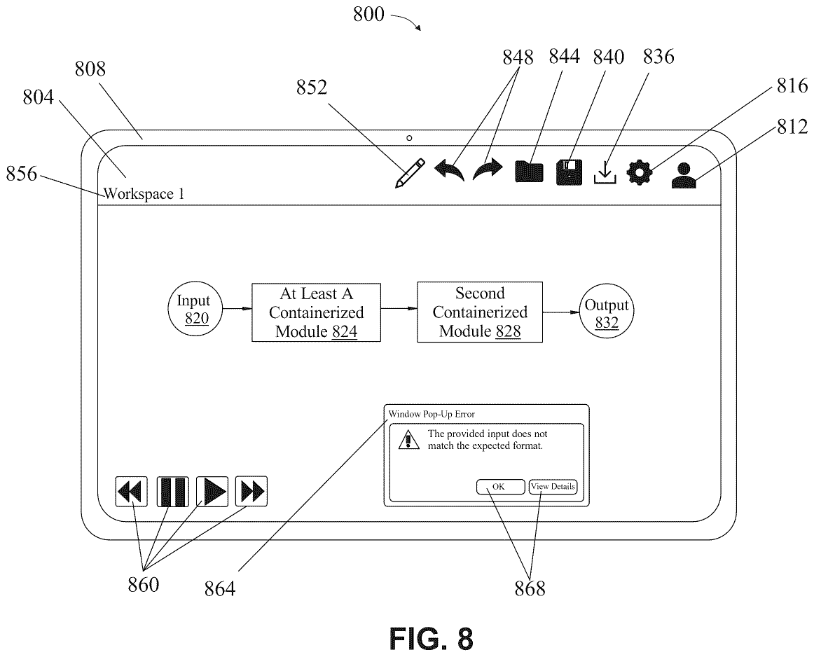

Referring now to FIG. 8, an exemplary illustration of a graphical user interface 800. In an embodiment, the graphical user interface (GUI) 804 may be displayed on a downstream device 808. In an embodiment, the downstream device 808 may include a smartphone, tablet, or computer. In an embodiment, the GUI 804 may include a user profile icon 812. In an embodiment, the user profile icon 812 may serve as an interactive element that allows users to access and manage their personal account settings. In an embodiment, the user profile icon 812 may provide a direct link to the user's profile, where they may update personal information, review activity history, and configure preferences related to their interactions within the system. In an embodiment, the user profile icon 812 may enable users to modify details such as their name, contact information, medical history, or security settings. In an embodiment, the user profile icon 812 may serve as a gateway to account-related features, including login credentials, privacy controls, and system permissions. In an embodiment, the user profile icon 812 may support multi-user functionality, allowing different users to switch profiles or customize their experience within the same system. In an embodiment, the user profile icon 812 may incorporate a visual indicator, such as a profile picture placeholder, initials, or a silhouette, providing a recognizable representation of the user. In an embodiment, the user profile icon 812 may include a notification badge, alerting users to profile-related updates, messages, or required actions. In an embodiment, the user profile icon 812 may facilitate seamless user management and personalization within the GUI 804. In an embodiment, the GUI 804 may include a gear icon 816. The GUI 804 may incorporate a gear icon 816, which may provide access to system settings, allowing users to customize preferences, adjust configurations, or manage administrative controls. In an embodiment, the GUI 804 may include an input visual element 820. The input visual element 820 may provide a user interface component for receiving input data required for processing within the system. In an embodiment, the input visual element 820 may allow users to manually enter data, upload files, or select input parameters from predefined options to facilitate seamless data integration.

Still referring to FIG. 8, in an embodiment, the GUI 804 may include at least a containerized module visual element 824. In an embodiment, the at least a containerized module visual element 824 may visually represent a deployed containerized module within the system's workflow. In an embodiment, the at least a containerized module visual element 824 may display module details, including configuration settings, execution status, and dependencies, to enhance user understanding of the processing pipeline. In an embodiment, the GUI 804 may include a second containerized module visual element 828. In an embodiment, the second containerized module visual element 828 may represent an additional containerized module within the workflow. In an embodiment, the second containerized module visual element 828 may establish a visual connection with the first containerized module visual element 824 to illustrate dependencies and data flow between the modules. In an embodiment, the GUI 804 may include an output visual element 832. In an embodiment, the output visual element 832 may provide a graphical representation of the processed output generated by the containerized module. In an embodiment, the output visual element 832 may display results in various formats, including text, images, or structured data tables, allowing users to review and interpret the generated output effectively. In an embodiment, the GUI 804 may include a download button 836. In an embodiment, the download button 836 may enable users to export processed data in a selected format for external use. In an embodiment, the download button 836 may support file formats such as CSV, JSON, or XML to facilitate data compatibility with other systems. In an embodiment, the GUI 804 may include a save button 840. In an embodiment, the save button 844 may allow users to store their current session, including input parameters and workflow configurations, for future use. In an embodiment, the save button 840 may provide options for local or cloud storage to ensure accessibility across multiple devices. In an embodiment, the GUI 804 may include an open button 844. In an embodiment, the save button 844 may allow users to retrieve previously saved workflows or configurations for continued processing. In an embodiment, the open button 844 may integrate with version control systems to track changes and manage different iterations of a workflow. In an embodiment, the GUI 804 may include an undo/redo button 848. In an embodiment, the undo/redo button 848 may provide functionality to revert or restore recent changes made within the user interface. In an embodiment, the undo/redo button 848 may allow users to navigate through previous modifications, ensuring flexibility in workflow adjustments. In an embodiment, the GUI 804 may include an edit button 852. In an embodiment, the edit button 852 may enable users to modify parameters, configurations, or module settings directly within the interface. In an embodiment, the edit button 852 may support inline editing or a separate configuration panel for making adjustments. In an embodiment, the GUI 804 may include a header 856. In an embodiment, the header 856 may display workflow titles, project names, or system status information to provide users with contextual awareness of their session. In an embodiment, the header 856 may also include navigational elements such as breadcrumbs or dropdown menus for improved user experience. In an embodiment, the GUI 804 may include process sequence buttons 860. In an embodiment, the process sequence buttons 860 may allow users to define, modify, or rearrange the execution order of containerized modules within the system. In an embodiment, the process sequence buttons 860 may enable drag-and-drop functionality or predefined workflow templates for efficient setup. In an embodiment, the GUI 804 may include an error message 864. In an embodiment, the error message 864 may notify users of input or processing errors detected during execution. In an embodiment, the error message 864 may include at least a user option 868, which may provide suggestions for resolving the detected issue. In an embodiment, the at least a user option 868 may allow users to view details, correct input errors, or apply system-recommended fixes to ensure smooth processing. In an embodiment, the error message 864 may include at least a user option 868. In an embodiment, the at least a user option 868 may allow users to view details, correct input errors, or apply system-recommended fixes to ensure smooth processing.

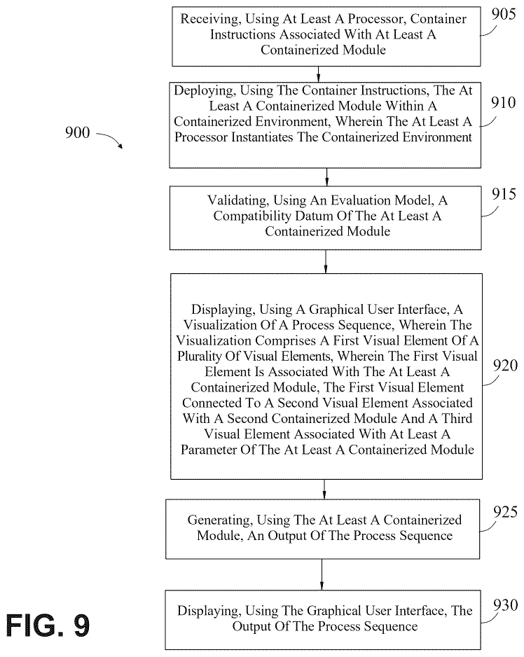

Referring now to FIG. 9, a flow diagram of an exemplary method 900 for generating an extensible architecture comprising at least a containerized module is illustrated. At step 905, method 900 includes receiving, using at least a processor, container instructions associated with at least a containerized module. In an embodiment, the container instructions may include at least source code of the at least a containerized module. In an embodiment, the at least a containerized module may include an imaging task, wherein the imaging task comprises generating, using at least an optical device, a first scan of an object at a first magnification, executing, using at least a processor, a region of interest detection algorithm on the first scan to determine at least a first parameter, configuring the at least an optical device using the at least a first parameter, generating, using the at least an optical device, a second scan as a function of a detected region of interest of the first scan at a second magnification, and comparing, using an analysis algorithm, the second scan to a plurality of high magnification images. In an embodiment, the at least a containerized module may include an obfuscation task, wherein the obfuscation task comprises receiving, using the at least a processor, an input comprising at least an identification, executing, using the at least a processor, an obfuscation algorithm on the input, and generating, using the at least a processor, obfuscated image as a function of the obfuscation algorithm. In an embodiment, the at least a containerized module may include a container system, wherein the container system is configured to encapsulate container instructions, deploy, using the container instructions, container operations across computing environments, and execute, using the container instructions, the container operations across computing environments. This may be implemented as described and with reference to FIGS. 1-8.

Still referring to FIG. 9, at step 910, method 900 includes deploying, using the container instructions, the at least a containerized module within a containerized environment, wherein the at least a processor instantiates the containerized environment. This may be implemented as described and with reference to FIGS. 1-8.

Still referring to FIG. 9, at step 915, method 900 includes validating, using an evaluation model, a compatibility datum of the at least a containerized module. In an embodiment, validating the compatibility datum of the at least a containerized module may include identifying, using the evaluation model, an error associated with an input format of the at least a containerized module, determining a transformation required to resolve the error, and generating, using the evaluation model, a recommendation datum to apply the transformation. In an embodiment, the evaluation module may include a machine learning model trained using a recommendation training dataset, wherein the recommendation training dataset comprises historical recommendations associated with historical errors. This may be implemented as described and with reference to FIGS. 1-8.

Still referring to FIG. 9, at step 920, method 900 includes displaying, using a graphical user interface, a visualization of a process sequence, wherein the visualization comprises a first visual element of a plurality of visual elements, wherein the first visual element is associated with the at least a containerized module, the first visual element connected to a second visual element associated with a second containerized module, and a third visual element associated with at least a parameter of the at least a containerized module. This may be implemented as described and with reference to FIGS. 1-8.

Still referring to FIG. 9, at step 925, method 900 includes generating, using the at least a containerized module, an output of the process sequence. This may be implemented as described and with reference to FIGS. 1-8.

Still referring to FIG. 9, at step 930, method 900 includes displaying, using the graphical user interface, the output of the process sequence. In an embodiment, the at least a processor may be further configured to generate a developer portal, wherein the developer portal receives user input and generates a third-party module as a function of the user input. In an embodiment, the developer portal may include generating at least a testing environment, wherein the testing environment is configured to execute the third-party module in an isolated manner to evaluate one or more functions. In an embodiment, the apparatus may further include a module repository, wherein the at least a processors further configured to receive the third-party module, store, using the module repository, the third-party module, and distribute the third-party module. This may be implemented as described and with reference to FIGS. 1-8.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

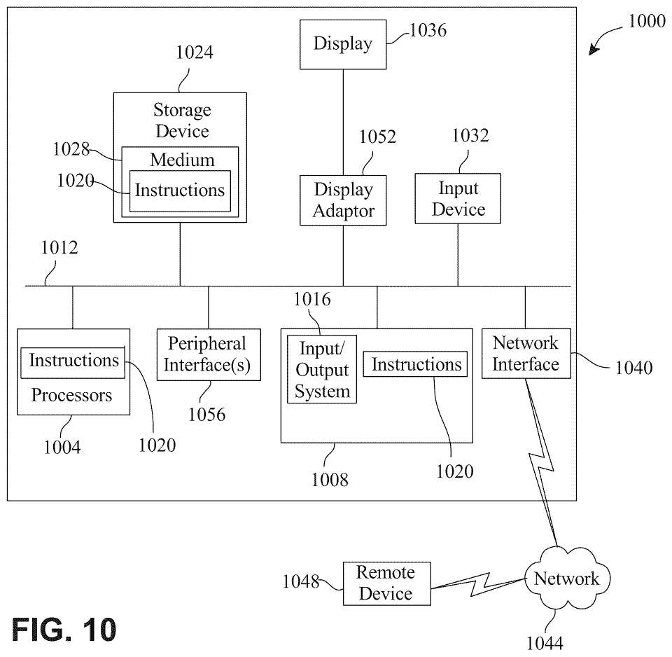

FIG. 10 shows a diagrammatic representation of one embodiment of computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display device 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for generating an extensible architecture comprising at least a containerized module, wherein the apparatus comprises:
at least a computing device, wherein the computing device comprises:
a memory; and
at least a processor communicatively connected to the memory, wherein the memory contains instructions configuring the at least a processor to:
receive container instructions associated with at least a containerized module;
deploy, using the container instructions, the at least a containerized module comprising an imaging task within a containerized environment, wherein the at least a processor instantiates the containerized environment, wherein the containerized module is configured to generate, using at least an optical device, a first scan of an object;
validate, using an evaluation model, a compatibility datum of the at least a containerized module;
display, using a graphical user interface, a visualization of a process sequence, wherein the visualization comprises:
a first visual element of a plurality of visual elements, wherein the first visual element is associated with the at least a containerized module, the first visual element connected to a second visual element associated with a second containerized module comprising an analysis algorithm configured to receive the first scan and implement machine learning model performing a similarity analysis to extract key features from the first scan; and
a third visual element associated with at least a parameter, wherein the third visual element is associated with the at least a containerized module, wherein the at least a parameter is a function of the key features extracted using the containerized module;
generate, using the at least a containerized module, an output of the process sequence; and
display, using the graphical user interface, the output of the process sequence.

2. The apparatus of claim 1, wherein the at least a containerized module:
receives the at least a parameter;
generates, using the at least an optical device, a second scan as a function of the at least a parameter.

3. The apparatus of claim 1, wherein the at least a containerized module comprises an obfuscation task, wherein the obfuscation task comprises:
receiving, using the at least a processor, an input image comprising at least an identification;
executing, using the at least a processor, an obfuscation algorithm on the input image; and
generating, using the at least a processor, obfuscated image as a function of the obfuscation algorithm.

4. The apparatus of claim 1, wherein the container instructions comprise at least source code of the at least a containerized module.

5. The apparatus of claim 1, wherein validating the compatibility datum of the at least a containerized module comprises:
identifying, using the evaluation model, an error associated with an input format of the at least a containerized module, wherein the input format relates to an attribute related to an execution of a module;
determining a transformation required to resolve the error, the transformation including one or more operations selected from data type conversion, schema mapping, value normalization, or parameter augmentation to enable seamless processing by the at least a containerized module; and
generating, using the evaluation model, a recommendation datum to apply the transformation, the recommendation datum including at least inclusion of a module capable of generating a parameter that is missing from the at least a containerized module.

6. The apparatus of claim 1, wherein the evaluation module comprises a machine learning model trained using a recommendation training dataset, wherein the recommendation training dataset comprises historical recommendations associated with historical errors.

7. The apparatus of claim 1, wherein the at least a containerized module comprises a container system, wherein the container system is configured to:
encapsulate container instructions;
deploy, using the container instructions, container operations across computing environments; and
execute, using the container instructions, the container operations across computing environments.

8. The apparatus of claim 1, wherein the at least a processor is further configured to generate a developer portal, wherein the developer portal:
receives user input; and
generates a third-party module as a function of the user input.

9. The apparatus of claim 8, wherein the developer portal comprises:
generating at least a testing environment, wherein the testing environment is configured to execute the third-party module in an isolated manner to evaluate one or more functions.

10. The apparatus of claim 8, wherein the at least a processor is further configured to:
retrieve, using a module repository, the third-party module;
store, using the module repository, the third-party module; and
distribute the third-party module.

11. A method for generating an extensible architecture comprising at least a containerized module, wherein the method comprises:
receiving, using at least a processor, container instructions associated with at least a containerized module comprising an imaging task;
deploying, using the container instructions, the at least a containerized module within a containerized environment, wherein the at least a processor instantiates the containerized environment, wherein the containerized module is configured to generate, using at least an optical device, a first scan of an object;
validating, using an evaluation model, a compatibility datum of the at least a containerized module;
displaying, using a graphical user interface, a visualization of a process sequence, wherein the visualization comprises:
a first visual element of a plurality of visual elements, wherein the first visual element is associated with the at least a containerized module, the first visual element connected to a second visual element associated with a second containerized module comprising an analysis algorithm configured to receive the first scan and implement machine learning model performing a similarity analysis to extract key features from the first scan; and
a third visual element associated with at least a parameter, wherein the third visual element is associated with of the at least a containerized module, wherein the at least a parameter is a function of the key features extracted using the containerized module;
generating, using the at least a containerized module, an output of the process sequence; and
displaying, using the graphical user interface, the output of the process sequence.

12. The method of claim 11, wherein the at least a containerized module:
receives the at least a parameter;
generates, using the at least an optical device, a second scan as a function of the at least a parameter.

13. The method of claim 11, wherein the at least a containerized module comprises an obfuscation task, wherein the obfuscation task comprises:
receiving, using the at least a processor, an input image comprising at least an identification;
executing, using the at least a processor, an obfuscation algorithm on the input image; and
generating, using the at least a processor, obfuscated image as a function of the obfuscation algorithm.

14. The method of claim 11, wherein the container instructions comprise at least source code of the at least a containerized module.

15. The method of claim 11, wherein validating the compatibility datum of the at least a containerized module comprises:
identifying, using the evaluation model, an error associated with an input format of the at least a containerized module, wherein the input format relates to an attribute related to an execution of a module;
determining a transformation required to resolve the error, the transformation including one or more operations selected from data type conversion, schema mapping, value normalization, or parameter augmentation to enable seamless processing by the at least a containerized module; and
generating, using the evaluation model, a recommendation datum to apply the transformation, the recommendation datum including at least inclusion of a module capable of generating a parameter that is missing from the at least a containerized module.

16. The method of claim 11, wherein the evaluation module comprises a machine learning model trained using a recommendation training dataset, wherein the recommendation training dataset comprises historical recommendations associated with historical errors.

17. The method of claim 11, wherein the at least a containerized module comprises a container system, wherein the container system is configured to:
encapsulate container instructions;
deploy, using the container instructions, container operations across computing environments; and
execute, using the container instructions, the container operations across computing environments.

18. The method of claim 11, wherein the at least a processor is further configured to generate a developer portal, wherein the developer portal:
receives user input; and
generates a third-party module as a function of the user input.

19. The method of claim 18, wherein the developer portal comprises:
generating at least a testing environment, wherein the testing environment is configured to execute the third-party module in an isolated manner to evaluate one or more functions.

20. The method of claim 18, further configured to:
retrieve, using a module repository, the third-party module;
store, using the module repository, the third-party module; and
distribute the third-party module.
